(19) United States
(12) Patent Application Publication
(10) Pub. No.: US 2002/0146489 A1
(43) Pub. Date: Oct. 10, 2002

(54) Aromatized carton with delayed release fragrances

(76) Inventors: Bruce J. Thoman, Lebanon, OH (US); Tim M. Fairchild, Loveland, OH (US); Michael S. Mabee, Mason, OH (US); Christopher S. Cleveland, Cincinnati, OH (US)

Correspondence Address: Hoffman, Wasson & Gitler, P.C., Suite 522, 2361 Jefferson Davis Highway, Arlington, VA, 22202, US

(21) Appl. No.: 09/828,807

(22) Filed: Apr. 10, 2001

(51) Int. Cl. A23B 4/00

(52) U.S. Cl. 426/112

(57) ABSTRACT

The present invention relates to an improved container for food and non-food products. The container utilizes a novel delayed release process to overcome polymer odor-emission problems that detract from a packaged product. The novel process utilizes fragrance molecules or microcapsules which have fragrance molecules contained therein, to impart an enhanced fragrance to the product when the container is opened, increasing consumer appeal.

### BACKGROUND OF THE INVENTION

The present invention relates to novel carton structures which contain a delayed release flavor/fragrance packet. More particularly, this invention relates to cartons which contain packets containing microcapsules with molecules having high load levels of flavors or fragrances which effectively address the problem of unwanted odor emissions from polymers, and effectively enhance the aroma of the packaged liquid or solid, food, or non food, product by enhancing the aroma of its container.

Various structures have been utilized to store liquid or solid, food or non-food, products. A widely known and used container is a paperboard based structure which is coated with various barrier and sealant materials. One basic structure is utilized in the half-gallon juice carton. This structure makes use of a three-layer laminate wall structure. The laminate comprises a paperboard substrate coated on both sides by a layer of low density polyethylene.

A second widely known structure makes use of a five-layer laminate wall structure. The half-gallon container laminate is comprised of a paperboard substrate, a layer of low density polyethylene coated on the exterior atmosphere-contact side of the substrate, a layer of a barrier material, such as aluminum foil, laminated onto the interior product-contact side of the substrate with a polymer layer of low density polyethylene, and a third layer of low density polyethylene coated onto the foil layer rendering the structure heat-sealable from front to back.

Adhesive tie layers, such as ethylene-acrylic acid copolymers, have also been used in the structure to better secure the foil layer in the structure. In addition, various other barrier materials have been utilized to combat the transfer of various gases, light, and flavors into and out of the container. The outer atmosphere-contact and inner food contact layers, whether merely a heat sealable polymer material such as low density polyethylene (LDPE) or a heat-sealable barrier material such as an ethylene vinyl alcohol copolymer (EVOH), can emit unwanted odors when heat is applied during extrusion coating or package converting/sealing. These odors can detract from the packaged product's organoleptic appeal.

A second popular container used to store liquid or solid, food, or non-food, products is a high density polyethylene (plastic) container. The half-gallon size container is constructed of high density polyethylene (HDPE) with a 21 mil. average wall thickness. The molding processes which are involved in producing such containers can often initiate degradation (oxidation) of the HDPE, causing the emission of unwanted odors which can be detrimental to the packaged product.

Consequently, in both plastic containers and/or existing commercial structures for paperboard cartons for liquid and solid, food and non food products odor-emission problems can occur as a result of thermal degradation of polymers. These odors detract from the packaged product.

An object of the present invention is to overcome the deficiencies of the conventional paperboard container and thermoplastic container by incorporating an unique flavor and/or fragrance packet in or around the pour spout of the carton to enhance the aroma of the packaged product through enhancement of the aroma of its container.

Another object of the present invention is to provide flavor and/or fragrance product enhancement for all sizes and types of liquid, or solid, food, or non-food, containers including four-ounce to 128-ounce paperboard or plastic containers, to improve the market appeal of the product.

A further object of this invention is to incorporate a delayed release fragrance packet into a paperboard or plastic container for enhancement over the use-life for the package.

### SUMMARY OF THE INVENTION

The preferred embodiment of the present invention reveals the use of flavor and/or fragrance concentrated molecules, or packets, in the product-contact polymer layer or other buried polymeric layers for foil based and non-foil based, food and non-food, liquid or solid container composite structures to impart an enhanced fragrance when the cartons or containers, made from various materials, are opened to dispense the product.

A laminate, side-seamed blank or container embodying the attributes of the invention can be produced by coating onto the product-contact polymer layer, other buried polymeric layer, a blend of a flavor and/or fragrance concentrated molecules and a virgin low density polyethylene, or a blend of a flavor and/or fragrance polymer concentrated molecules and a barrier polymeric material, in a multi-layer paperboard laminate carton structure or into high density polyethylene container.

The cartons, side-seamed blanks, or containers which contain the unique blend polymeric layer produce structures which overcome the problems of unwanted odors emitted by packaging materials, and which impart an enhanced fragrance to the product when the container is opened, increasing consumer appeal. In addition, during the flavor and/or fragrance concentrated molecules virgin low density polyethylene polymer blend's incorporation into paperboard laminate structures, the laminate retains the desirable feature of heat-sealability from front to back, with its exterior and interior layers acting like, non polar constituent materials which can be easily heat-sealed.

### BRIEF DESCRIPTION OF THE DRAWINGS

FIG. 1 is a cross sectional elevation of a laminate embodying a preferred embodiment of the invention;

FIG. 2 is a cross-sectional elevation of a laminate embodying an alternate embodiment of the invention;

FIG. 3 is an illustration of a top of a gable top carton having a spout which is covered by a cap; and

FIG. 4 is a cross-sectional elevation of a laminate embodying an alternate embodiment of the present invention.

### DETAILED DESCRIPTION OF THE INVENTION

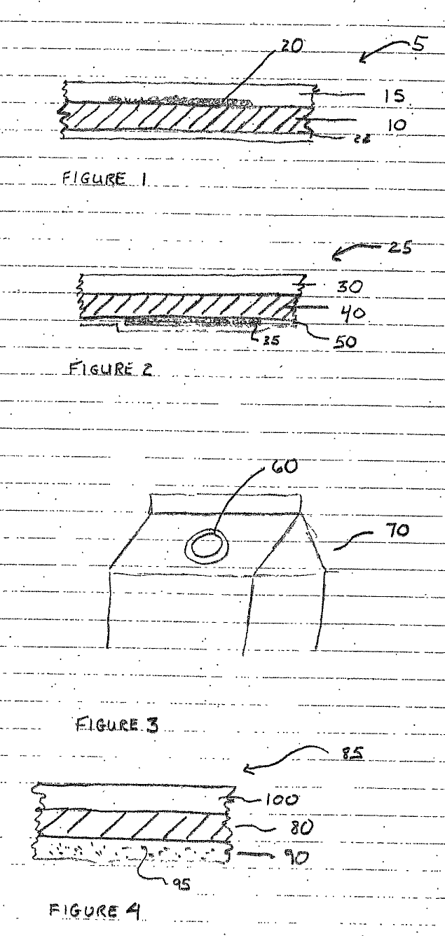

Turning now to the drawings, FIG. 1 is a cross-sectional depiction of a cap 5. The cap 5 has a plastic substrate 15, with a foil liner 10, and flavor molecules or a packet of flavor microcapsules 20 which embody a flavor fragrance concentrate. The molecules or microcapsules 20 are delayed release and enhance the aroma and flavor perception of a product contained in the carton or container. There is also provided a polymer seal layer 22 covering the foil layer 10.

An alternate embodiment of the cap 25, is displayed in FIG. 2. The cap 25 includes a plastic structural substrate 30, a foil layer 40, a foil polymeric seal layer 50, and a packet of microcapsules 35 or dispersed flavor molecules located between the foil layer 40 and the polymeric sealant layer 35.

FIG. 3 is a depiction of a gable-top paperboard carton 70, with a spout 60. The spout is covered by a cap which covers the spout 60.

In a standard paperboard based half-gallon (or other size) juice carton, product fragrance or aroma is affected by the polymer odor emission problem and the perceived quality of the juice product is diminished. The caps embodied by the laminates of FIGS. 1 and 2 release flavor or fragrance enhancement over time to make the perception of an improved product quality over time.

FIG. 4 depicts an alternate embodiment of the structures of FIGS. 1 and 2. The molecules themselves or the microcapsules 95 are blended into a polymer material 90 which can be a virgin low density polyethylene or a barrier polymeric material such as an ethylene vinyl alcohol copolymer, a polyester, or the like. The cap structure 95 has a plastic substrate 100, a foil layer 80 and the blend polymeric layer 90.

The flavor and/or fragrance concentrate packet or the flavor fragrance molecules is FDA approved for food contact. The flavor and/or fragrance concentrate microcapsules or molecules are blended, as required, with FDA approved food contact polymers. The blend allows the concentrate to be heat sealed with other polymer layers in paperboard or other similar applications and allows the concentrate to be combined with high density polyethylene, low density polyethylene, polypropylene, polyethylene terephthalate (PET) in blow molded and injection molded thermoplastic applications.

Tie layer materials such as ionomers, ethylene acrylic acid copolymers, or ethylene-methacrylic acid copolymers are all suitable for the structure and can be incorporated into the cap laminate as desired.

Some materials which can function to meet the requisite barrier properties desired are foil, ethylene vinyl alcohol copolymer, polyethylene terephthalate, glycol-modified polyethylene terephthalate, acid modified polyethylene terephthalate, polybutylene terephthalate, polyvinyl alcohol, vinylidene chloride copolymer, polyvinyl chloride polymer, vinyl chloride copolymer, polyamide polymer, polyamide copolymer and polycarbonate polymer.

Other materials which can be extruded or laminated into a board laminate structure, which can provide the desired results, could also be utilized to practice the invention.

The particular polymer flavor/fragrance concentrate selected or the amount utilized usually in the range of 0.25-12.0% is determined by the specific application.

In a conventional half-gallon orange juice container, for example, an orange flavored concentrate is incorporated into the cap or spout thereby enhancing the aroma/fragrance of the packaged orange juice each time the package is opened through uniform, controlled and delayed release of the fragrance throughout the life of the product.

The blend of the low density polyethylene polymer and polymer flavor/fragrance concentrate or barrier polymer material and polymer flavor/fragrance concentrate in situations where applicable (paperboard containers) will heat-seal with a layer of a low density polyethylene polymer on conventional equipment at temperatures ranging from 250° F. to 500° F.

The description of the preferred embodiments is meant to be illustrative of the scope and spirit of the invention. These preferred structures will make apparent other embodiments and examples, within the scope and spirit of the invention described herein. These other embodiments and examples, within the scope and spirit of this invention, are within contemplation of this invention. Therefore, the invention should only be limited by the appended claims.

What is claimed is:

1. A aromatized carton for liquid food products comprising:
a package for containing the liquid food product; and
a delayed release fragrance packet having fragrance molecules which diffuse from microcapsules contained in the packet, the packet being contained within the package.

2. The aromatized carton as claimed in claim 1, wherein the carton further comprises a pour spout with a cap and a foil seal layer located below the cap, wherein the packet containing the microcapsules is applied to the foil seal layer between the cap and the foil seal layer.

3. The aromatized carton as claimed in claim 1, wherein the carton further comprises a pour spout with a cap and a foil seal layer located below the cap, wherein the packet containing the packet containing the microcapsules is applied directly to a cap liner facing the spout.

4. The aromatized carton as claimed in claim 1, wherein the carton further comprises a pour spout with a cap and a foil seal layer located below the cap, wherein the packet containing the packet containing the microcapsules is applied in a hot melt between the cap and a cap liner.

5. The aromatized carton as claimed in claim 1, wherein the carton further comprises a pour spout with a cap and a foil seal layer located below the cap, wherein the packet containing the packet containing the microcapsules is placed in a resin coating on a cap liner.

6. The aromatized carton as claimed in claim 1, wherein the carton further comprises a pour spout with a cap, wherein the microcapsules are compounded as part of the spout.

7. The aromatized carton as claimed in claim 1, wherein the carton further comprises a pour spout with a cap, wherein the microcapsules are compounded as part of the cap.

8. A aromatized carton for liquid food products comprising:
a package for containing the liquid food product; and
delayed release fragrance molecules compounded into package materials which diffuse from microcapsules which contain the molecules.

9. A aromatized carton for liquid food products comprising:
a package for containing the liquid food product; and
delayed release fragrance molecules incorporated into a cap, liner or spout of the carton.
